(19) United States
(12) Patent Application Publication
(10) Pub. No.: US 2010/0238203 A1
(43) Pub. Date: Sep. 23, 2010

(54) DRIVING PIXELS OF A DISPLAY

(75) Inventors: Jan Stroemer, Eindhoven (NL); Erno Hermanus Antonius Langendijk, Eindhoven (NL); Franciscus Paulus Maria Budzelaar, Eindhoven (NL); Oleg Belik, Eindhoven (NL); Nathalie Magali Danielle Dessaud, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/741,049

(22) PCT Filed: Nov. 3, 2008
(86) PCT No.: PCT/IB08/54562

§ 371 Date: May 3, 2010

(30) Foreign Application Priority Data
Nov. 8, 2007 (EP) 07120268.3

(51) Int. Cl. G06F 3/038

(52) U.S. Cl. 345/690

(57) ABSTRACT

A driver (106) for driving pixels (104) of a display (102), wherein the pixels are divided into a first group and a second group and the driver is constructed for supplying a first drive signal to a first pixel and a second drive signal to a second pixel, the first and second pixels being neighboring pixels. The driver (106) comprises means for generating a first upper value and a first lower value; and means for generating a second upper value and a second lower value. It comprises means for driving, in a first operating mode, the first pixel with the first lower value and driving the second pixel with the second upper value. In a second operating mode, driving the first pixel with the first upper value and driving the second pixel with the second lower value. Means (108) for controlling the operating mode alternates between the first operating mode and the second operating mode.

### FIELD OF THE INVENTION

The invention relates to driving pixels of a display.

### BACKGROUND OF THE INVENTION

Flat panel displays may be using liquid crystal display technology. Depending on the specifications of the system, the components used, and the circumstances in which they are used, such liquid crystal displays may suffer from a reduced image quality. For example, the image quality may be lower when viewing the display from an oblique viewing angle compared to when viewing the display from a viewing angle that is perpendicular to the plane of the display. Mid-range brightness values may be subject to gamma distortion when viewed from an oblique viewing angle. Accordingly, the image quality may be improved by using relatively low and/or relatively high brightness values. Mid-range brightness values may be rendered by rendering alternating low and high brightness values in a modified impulse driving method.

N. Kimura et al., in “New technologies for large-sized high-quality LCD TV”, which appeared in SID 2005 Digest, page 1734-1737, referred to hereinafter as “Kimura et al.”, mentions impulse driving methods to improve moving picture quality, in particular backlight impulse driving method and liquid crystal (LC) impulse driving method. The LC impulse driving method sacrifices the efficiency of backlights. Kimura et al. propose another impulse driving method based on a combination of half-frame rate driving and impulse driving method. Comparing to the conventional driving with 60 Hz, Kimura et al.'s driving method involves dividing a frame into two sub-frames. The actual gray-levels can be realized by the combination of the two levels given in these sub-frames. In case of black to half gray-level, the luminance of one sub-frame has a value between zero and the maximum value and in the case of levels from half gray-level to maximum, the luminance of another sub-frame also has values between zero and the maximum value. The total brightness of one pixel therefore becomes the summation of the luminances in such two sub-frames and the maximum brightness of this method is the same as a conventional LCD with the hold mode. According to Kimura et al., this driving method provides almost the same effect as an impulse driving method (with black frame insertion) without sacrificing maximum brightness.

However, artifacts, such as a flickering effect, may occur for certain frequencies.

### SUMMARY OF THE INVENTION

It would be advantageous to have an improved system for displaying an image on a display. To better address this concern, in a first aspect of the invention a system is presented wherein, in at least an area of the display, the pixels are divided into a first group and a second group, and the driver is constructed for supplying a first drive signal to a first pixel being one of the pixels out of the first group and a second drive signal to a second pixel being one of the pixels out of the second group, the first and second pixels being neighboring pixels;

wherein the driver comprises

a value generator for generating a first upper value and a first lower value, wherein the first upper value and the first lower value together correspond to a first pixel parameter value, the value generator being arranged for further generating a second upper value and a second lower value, wherein the second upper value and the second lower value together correspond to a second pixel parameter value; and

means for driving, in an operating mode, the first pixel with the first lower value and the second pixel with the second upper value.

The impulse driving method and the method of Kimura et al. render a sub-frame with all lower values followed by a sub-frame with all upper values. This may cause artifacts, for example flicker. Such artifacts may be overcome or at least reduced by, during a sub-frame, driving one pixel with one of the lower values and another pixel with one of the upper values. This causes a reduction of the artifacts. The pixel parameter may for example control a luminance of a particular sub-pixel of the display pixel. In another example, the pixel parameter may control the overall pixel luminance.

Neighboring pixels are preferably located such that two neighboring pixels have less than fifteen pixels of a same color or type located between them in a particular direction (horizontally, vertically or diagonally). This distance ensures that a reduction of the mentioned artefacts is achieved. In case the display is viewed from a relatively short viewing distance, e.g. less then 4 times the height of the display, preferably the two neighboring pixels are located such that they have less than three pixels of a same color or type located between them in a particular direction.

Hereinafter, the above mentioned operating mode of the means for driving is referred to as the first operating mode.

In an embodiment, the means for driving is further arranged for, in a second operating mode, driving the first pixel with the first upper value and driving the second pixel with the second lower value, and the system further comprises means for controlling the operating mode, alternating between the first operating mode and the second operating mode. This allows to alternate the role of the two groups. By alternating the role of the two groups, both upper values and lower values are displayed one after the other. Because one pixel is driven with a lower value and another pixel is driven with an upper value, the combined image intensity of the two pixels does not vary very much between the first and second operating mode. This prevents introduction of artifacts, such as flicker.

In an embodiment, the means for controlling the operating mode is arranged for alternating between the operating modes at a rate substantially equal to a frame rate of the display. The higher the frequency in time of alternating between lower values and upper values in a display pixel, the less visible are any artifacts. By alternating the lower and higher values, e.g. in each screen refresh or at the field rate of the display, the frequency becomes relatively high, which makes the undesirable flickering effect less visible.

In an embodiment, the means for controlling the operating mode is arranged for alternating between the operating modes at a rate substantially half a frame rate of the display. This way, a DC build-up is avoided when the display employs a “plus, minus, plus, minus with time” electrode inversion scheme.

In an embodiment, the driver is arranged for driving the plurality of display pixels to render a sequence of images of a video sequence, wherein each image of the sequence of images is associated with a corresponding first pixel parameter value and a corresponding second pixel parameter value; and the means for controlling the operating mode is arranged for causing the driver to apply both the first operating mode and the second operating mode to each image. This way, both upper and lower values are effected for each image in the video sequence. This way, the correct luminance values are rendered for each image. For example, for each image, first the first operating mode is activated and subsequently the second operating mode is activated.

In an embodiment, a frame rate of the display is substantially two times a frame rate of the video sequence. This allows to display both upper values and lower values in succession and still keep up with the frame rate of the video sequence.

In an embodiment, the means for controlling the operating mode is arranged for successively applying the first operating mode to a first image of the video sequence, applying the second operating mode to the first image of the video sequence, applying the second operating mode to a second image of the video sequence, and applying the first operating mode to the second image of the video sequence, wherein the first image and the second image are sequential images of the video sequence. This pattern is repeated for the following images in the video sequence, so that an operating mode is applied two times before switching to the other operating mode. This way, a DC build-up is avoided when the display employs a “plus, minus, plus, minus with time” electrode inversion scheme.

In an embodiment, substantially each display pixel in the first one of the at least two groups of display pixels is adjacent to a display pixel in another one of the at least two groups of display pixels and substantially each display pixel in the second one of the at least two groups of display pixels is adjacent to a display pixel in another one of the at least two groups of display pixels. This ensures that the groups are finely distributed over the display, which reduces any artifacts.

In an embodiment, the adjacent display pixels of a given display pixel in horizontal and vertical direction are not in the same group as the given display pixel. This corresponds to a checkerboard pattern, which is highly effective for avoiding artifacts.

In an embodiment, the adjacent display pixels of a given display pixel in either one of horizontal and vertical direction are not in the same group as the given display pixel, but the adjacent display pixels of the given display pixel in another one of horizontal and vertical direction are in the same group as the given display pixel. This corresponds to a ‘line’ pattern, which is also very effective for avoiding artifacts and is relatively easy to implement.

In an embodiment, the value generator is arranged for further generating a third upper value and a third lower value, wherein the third upper value and the third lower value together correspond to a third pixel parameter value, wherein the first pixel parameter and the third pixel parameter represent mutually different sub-pixels; and wherein the value generator is arranged for further generating a fourth upper value and a fourth lower value, wherein the fourth upper value and the fourth lower value together correspond to a fourth pixel parameter value, wherein the second pixel parameter and the fourth pixel parameter represent mutually different sub-pixels. This way, the lower and upper values may be very finely distributed, at the sub-pixel level. This further reduces the artifacts. This is particularly so if the means for driving is arranged for driving, in the first operating mode, the first pixel with the first lower value and the third upper value and driving the second pixel with the second upper value and the fourth lower value and wherein the means for driving is arranged for driving, in the second operating mode, the first pixel with the first upper value and the third lower value and driving the second pixel with the second lower value and the fourth upper value.

In an embodiment, the display is a color sequential display. For example, the value generator is arranged for generating upper and lower values for at least three pixel color parameters of a pixel, and wherein the means for driving is arranged for driving the pixel consecutively with the lower pixel color parameter values and for driving the pixel consecutively with the upper pixel color parameter values. This way, at least three low drive values are applied consecutively and three upper drive values are applied consecutively. The average difference between consecutive drive values thus becomes relatively small, which allows the liquid crystal to attain the correct transparency within a shorter time. This allows to increase the duty cycle (longer backlight flash) and/or allows to increase the frame rate (or field rate). It reduces crosstalk.

An embodiment comprises means for identifying a first area of an image to be displayed and a second area of the image to be displayed, wherein the first area has more picture detail than the second area, wherein the area of the display corresponds to the first area of the image, and the system further comprises means for driving display pixels in an area of the display corresponding to the second area of the image with the upper values and the lower values in phase. This allows to adapt the properties of the display to the level of picture detail in the image, further reducing artifacts.

An embodiment comprises a display device comprising a display and the driver according to claim 1. The display may be an LCD display or any other type of display benefiting from being driven according to the method of claim 17. The display may be for use in a direct view TV or monitor, for use in a rear projector or front projector, in a portable device such as PDA, mobile phone, or any other display application. In any of the above applications the display may be a transmissive, reflective or transflective type.

Further aspects of the invention are disclosed in the independent claims. The dependent claims define advantageous embodiments.

### BRIEF DESCRIPTION OF THE DRAWINGS

These and other aspects of the invention will be further elucidated and described with reference to the drawing, in which

FIG. 1 is a simplified diagram of an embodiment of the invention;

FIG. 2 shows a plurality of gamma curves;

FIG. 3 illustrates an example of an algorithm framework that may be used for choosing sub-frame luminance values;

FIG. 4 illustrates a checkerboard arrangement of groups of pixels;

FIG. 5 illustrates a line arrangement of groups of pixels;

FIG. 6 illustrates a checkerboard arrangement;

FIG. 7 illustrates embodiments using a “plus, minus, plus minus with time” inversion scheme;

FIG. 8 shows two diagrams of a detail of a grid of pixels of a display;

FIG. 9 illustrates embodiments involving a field sequential display.

### DETAILED DESCRIPTION OF EMBODIMENTS

The off-axis view of LCD displays is usually somewhat deteriorated from the view normal to the display surface. This may include the occurrence of gamma curve distortion and color shift. Liquid crystal displays (LCDs) may also suffer from motion blur.

To improve the off-axis view, two sub frames may be defined that replace one frame of the display and that follow each other in temporal succession. For example, the luminance is, if possible, displayed in only one single sub-frame and the second sub-frame is used for displaying the remainder of the luminance, if it was not possible to display the luminance in the single sub-frame. This leads to a bright frame followed by a dark frame and improves the motion blur similar to black frame insertion.

Alternatively, each pixel may be divided into two sub-pixels and these sub-pixels may be driven at different luminance levels. In yet another alternative, a doubling of the frame rate from e.g. 60 Hz to 120 Hz may be employed to reduce an off-axis color shift.

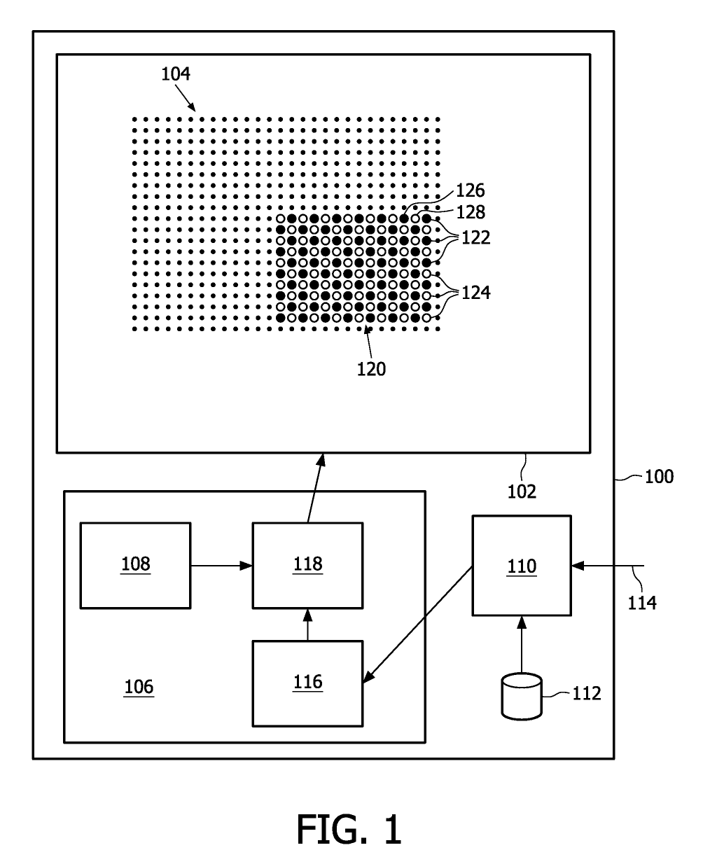

FIG. 1 illustrates an embodiment of the invention. The figure illustrates a display device 100 comprising a display 102 with a plurality of pixels 104. The display 102 may be a liquid crystal display (LCD). However the invention is not limited to LCD displays. The display 102 may be for use in a direct view TV or monitor, for use in a rear projector or front projector, in a portable device such as PDA, mobile phone, or any other display application. Also, the display may be a transmissive, reflective or transflective type. In the figure at reference numeral 104, the pixels are indicated schematically by dots. In an area 120 the pixels are drawn using larger dots and circles for illustrating certain aspects of the invention. The sizes and positions of the dots do not relate to any physical dimensions of the actual pixels 104 of the display 102. Only some of the pixels 104 of the display 102 have been schematically drawn in FIG. 1. Normally the display 102 comprises many more pixels 104 than drawn in the figure. The display device 100 further comprises a source 110 for providing pixel parameter value data to be used in the display device 100 for rendering one or more images on the display 102. The display device 100 further comprises a driver 106 for driving the pixels 104 of the display 102. The driver 106 may comprise a means for driving 118, a value generator 116, and a means 108 for controlling an operating mode of the means for driving 118.

The source 110 may obtain image and/or video data from an external source 114. To that end the source 110 may comprise a video input, for example SCART or HDMI interface, or an analog (e.g. coaxial) video input. The source 110 may also obtain the image and/or video data from a storage medium 112. Such a storage medium 112 may comprise, for example, flash memory, a hard disk, an optical disc such as a DVD disc, or a video tape. The source 110 extracts pixel parameter values from the obtained image and/or video data and forwards these pixel parameter values to the driver 106. This extraction may include scaling to adapt the image and/or video data to the resolution and/or framerate of the display 102. Scaling may also be performed by the driver 106. In this case the pixel parameter values are the values after scaling in the driver 106.

In at least an area 120 of the display, the pixels 104 are divided into a first group 122 (indicated by dark circles in the figure) and a second group 124 (indicated by white circles in the figure). The figure shows an example of how pixels may be allocated to the first group 122 and the second group 124 according to a checkerboard pattern. However, other arrangements of the groups are also possible. The driver 106 is constructed for supplying a first drive signal to a first pixel 126 which is one of the pixels out of the first group 122 and a second drive signal to a second pixel 128 which is one of the pixels out of the second group 124. The first pixel 126 and the second pixel 128 are neighboring pixels.

The value generator 116 is arranged for generating a first upper value and a first lower value, wherein the first upper value and the first lower value together correspond to a first pixel parameter value obtained from the source 110. The value generator is arranged for further generating a second upper value and a second lower value, wherein the second upper value and the second lower value together correspond to a second pixel parameter value obtained from the source 110. These upper and lower values may be generated as explained above in relation to dark and bright sub-frames. The pixel parameter values define values of a pixel parameter, wherein a pixel parameter may be used to drive the luminance and/or color of a pixel. For example, the pixel parameter controls the luminance of a sub-pixel, wherein the sub-pixel corresponds to a certain color, for example red, green, or blue.

The means 118 for driving is arranged for driving the first pixel with the first lower value and driving the second pixel with the second upper value. The means 118 for driving may be implemented as a driver circuit in hardware and/or in the form of software, for example, as a controller or as a software module that is executed on a processor. The means 118 for driving is a part of the driver 106. It receives the upper and lower values from the value generator 116. Its operating mode may be controlled by the means 108 for controlling. The means 118 for driving controls the information content of the drive signals that are supplied to the pixels 104 based on the received upper and lower values and based on the operating mode.

The means 118 for driving, the value generator 116 and/or the means 108 for controlling may be combined in one piece of hardware and/or one or more software modules.

In an embodiment, the means 108 for controlling an operating mode of the means for driving may be provided. This means 108 for controlling an operating mode may be implemented, for example, as a controller or as a software module. In a first operating mode, the means 118 for driving drives the first pixel with the first lower value and drives the second pixel with the second upper value. In a second operating mode, the means 118 for driving drives the first pixel with the first upper value and drives the second pixel with the second lower value. The means 108 for controlling the operating mode is arranged for alternating between the first operating mode and the second operating mode.

In an embodiment, the means 108 for controlling the operating mode is arranged for alternating between the operating modes at a rate substantially equal to a frame rate of the display.

In an embodiment, the means 108 for controlling the operating mode is arranged for alternating between the operating modes at a rate substantially half a frame rate of the display. Consequently, substantially after every second screen refresh, the operating mode is changed.

In an embodiment, the driver is arranged for driving the plurality of pixels 104 to render a sequence of images of a video sequence, wherein each image of the sequence of images is associated with a corresponding first pixel parameter value and a corresponding second pixel parameter value, generated by the value generator 116. The means 108 for controlling the operating mode may be arranged for causing the driver to apply both the first operating mode and the second operating mode to each image. This way, each image is rendered two times: in the first operating mode and in the second operating mode. This may be easily implemented if the frame rate of the display is substantially two times a frame rate of the video sequence.

In an embodiment, the means 108 for controlling the operating mode is arranged for successively applying the first operating mode to a first image of the video sequence, applying the second operating mode to the first image of the video sequence, applying the second operating mode to a second image of the video sequence, and applying the first operating mode to the second image of the video sequence, wherein the first image and the second image are sequential images of the video sequence. This pattern is repeated for the following images in the video sequence, so that an operating mode is applied two times before switching to the other operating mode. Some images are first rendered in the first operating mode and then in the second operating mode, whereas other images are first rendered in the second operating mode and then in the first operating mode. This may help prevent DC build-up to occur in the pixel's electrodes.

In an embodiment, substantially each pixel in the first one of the at least two groups of pixels is adjacent to at least one pixel in another one of the at least two groups of pixels. Also, substantially each pixel in the second one of the at least two groups of pixels is adjacent to at least one pixel in another one of the at least two groups of pixels. This is, for example, the case in the illustrated area 120. More particularly, in the illustrated embodiment the adjacent pixels of a given pixel in both horizontal and vertical directions are in a different group than the given pixel. This may result in a checkerboard pattern.

In another embodiment, the adjacent pixels of a given pixel in either one of horizontal and vertical direction are not in the same group as the given pixel, but the adjacent pixels of the given pixel in another one of horizontal and vertical direction are in the same group as the given pixel. This may result in a line pattern. Line patterns and checkerboard patterns are discussed in more detail elsewhere in this description.

In an embodiment, the value generator 116 is arranged for further generating a third upper value and a third lower value. The third upper value and the third lower value together may correspond to a third pixel parameter value. The first pixel parameter and the third pixel parameter may represent mutually different sub-pixels. The value generator (116) may be arranged for further generating a fourth upper value and a fourth lower value. The fourth upper value and the fourth lower value together may correspond to a fourth pixel parameter value. The second pixel parameter and the fourth pixel parameter may represent mutually different sub-pixels. For example, the first pixel parameter may represent a first sub-pixel of the first pixel 126, the second pixel parameter may represent a first sub-pixel of the second pixel 128, the third pixel parameter may represent a second sub-pixel of the first pixel 126, and the fourth pixel parameter may represent a second sub-pixel of the second pixel 128. For example, the first sub-pixel of the first pixel 126 and the first sub-pixel of the second pixel 128 have the same color, for example red. Likewise, the second sub-pixel of the first pixel 126 and the second sub-pixel of the second pixel 128 may have a same color, for example blue. More sub-pixels may be defined having corresponding pixel parameters and corresponding to another color, for example green. Upper and lower values may be generated for these sub-pixels by the value generator and provided to the means for driving, wherein the latter will drive the pixels with the upper and/or lower values based on the operating mode.

In the first operating mode, the means for driving may be arranged for driving the first pixel with the first lower value and the third upper value and driving the second pixel with the second upper value and the fourth lower value. Hereby, the appropriate corresponding sub-pixels may be controlled. In the second operating mode, the means for driving may be arranged for driving the first pixel with the first upper value and the third lower value and driving the second pixel with the second lower value and the fourth upper value.

In an embodiment, the display is a color sequential display. Such a color sequential display is arranged for rendering the different colors (e.g. red, green, or blue) of an image sequentially. Such color sequential displays are known in the art. A color sequential display may comprise a backlight modulated by an LCD panel. The backlight may quickly change its color according to a fixed, repetitive pattern, to enable rendering of a color image. The backlight may comprise different light sources (for example LED's) for the different colors, or it may comprise a white light source. In case the backlight comprises a white light source, a color filter wheel may be provided which is arranged for applying appropriate color filters sequentially. The color filter wheel and the white light source may be applied, for example, in a projection display. The value generator may be arranged for generating upper and lower values for at least three pixel color parameters of a pixel. The means for driving may be arranged for driving the pixel consecutively with the lower pixel color parameter values and for driving the pixel consecutively with the upper pixel color parameter values. Accordingly, the LCD experiences on average smaller jumps in the voltages applied to the electrodes of the pixel, which may result in reduced average latency.

The means for driving may be arranged for driving the pixel consecutively with the lower pixel parameter values and for driving the pixel consecutively with the upper pixel parameter values. This way, the pixels need to switch less frequently from lower values to upper values and back.

In an embodiment, means are provided for identifying a first area of an image to be displayed and a second area of the image to be displayed, wherein the first area has more picture detail than the second area. This may be performed by means of image processing techniques. For example, the variance of luminance or of red, green, and/or blue parameters may be determined for an area, wherein a larger variance may be associated with more picture detail than a smaller variance. Other and more advanced methods of establishing the amount of picture detail in an area of the image are known by the skilled person. For example multi-scale image analysis techniques may be used. The area 120 of the display 102 corresponds to the area with more picture detail. The area of the display corresponding to the area of the image with less picture detail may be driven with the upper values and the lower values in phase.

The driver 106 may be incorporated in a display device 100 comprising the display 102. The source 110 may be included in the display device 100. Alternatively, the source 110 and/or the storage means 112 may be provided in separate devices. It is also possible to implement the driver 106 as a separate device.

In an embodiment for rendering an image on the display 102, the display 102 comprises a plurality of display pixels 104. Individual display pixels 126 have associated therewith at least one pixel parameter for controlling a luminance of at least a sub-pixel of the display pixel 126. The image may comprise a plurality of image pixels, individual image pixels having associated therewith a lower value and an upper value of the pixel parameter, the lower value being smaller than or equal to the upper value, the lower value and the upper value associated with an image pixel together corresponding to a pixel parameter, for example a luminance and/or color attribute of the image pixel. The lower value and the upper value may be selected for improving an off-axis image quality. The plurality of display pixels are divided into at least two groups 122 and 124 of display pixels, wherein the display pixels in the different groups 122 and 124 of display pixels are, preferably, evenly distributed over an area 120 of the display. The driver 106 is arranged for driving the plurality of display pixels to render the image by means of the means for driving 118. The means for driving 118 may be arranged for, in the first operating mode, driving respective display pixels 126 in a first one 122 of the at least two groups of display pixels 104 with the respective lower values of the respective image pixels, and for driving respective display pixels 128 in a second one 124 of the at least two groups of display pixels 104 with the respective upper values of the respective image pixels. Of course, the image to be displayed may be obtained after resampling an image obtained from the source 110 to correspond to the pixel resolution of the display 102. To this end, a resolution converter or scaler (not shown) may be provided in the driver 106 and/or in the source 110.

In the second operating mode, the means 118 for driving may be arranged for driving the respective display pixels 104 in the first one 122 of the at least two groups of display pixels 104 with the respective upper values of the respective image pixels and driving the respective display pixels 104 in the second one 124 of the at least two groups of display pixels with the respective lower values of the respective image pixels. The means 108 for controlling the operating mode may be arranged for alternating between the first operating mode and the second operating mode.

According to a method of driving pixels 104 of a display, in at least an area of the display, the pixels are divided into a first group and a second group. The method comprises supplying a first drive signal to a first pixel being one of the pixels out of the first group and a second drive signal to a second pixel being one of the pixels out of the second group, the first and second pixels being neighboring pixels. The method further comprises generating a first upper value and a first lower value, wherein the first upper value and the first lower value together correspond to a first pixel parameter value; and generating a second upper value and a second lower value, wherein the second upper value and the second lower value together correspond to a second pixel parameter value. The first pixel is driven with the first lower value and the second pixel is driven with the second upper value.

In an embodiment, at least two operating modes are provided: In the first operating mode, the method comprises driving the first pixel with the first lower value and driving the second pixel with the second upper value. In the second operating mode, the method comprises driving the first pixel with the first upper value and driving the second pixel with the second lower value. The method may comprise alternating between the first operating mode and the second operating mode.

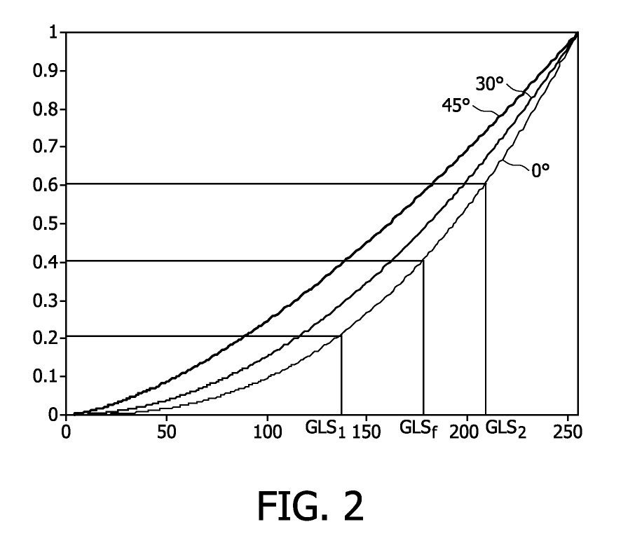

The graph shown in FIG. 2 schematically illustrates a suitable example of a relation between the normalized luminance (vertical axis) and the grey level signal (GLS, horizontal axis) for different examples of viewing angles of 0°, 30°, and 45° with respect to the normal (different curves marked 0°, 30°, and)45°. The curves are provided for illustrating the concept of a gamma curve. The exact shapes of the curves may not be representative of actually manufactured displays. It can be seen that the off-axis luminance error (i.e.: the difference between the different curves) is relatively small at low and high drive values. So, here a situation is depicted where the distortion is more in the mid-grey level region and less at the extreme ends of the drive signal values. Such a situation occurs usually in vertical aligned (VA) panels.

In such or similar panels it is advantageous to replace mid-grey drive values (e.g. GLS_{f}) by temporally successive high and low drive values (e.g. GLS₁ and GLS₂), whereby the resulting perceived luminance value corresponds to the original mid-grey luminance value GLS_{f} or comes very close to it. An aim is that the distortion of the new resulting gamma curve may be reduced, especially for off-axis viewing angles. Both luminance levels (e.g. GLS₁ and GLS₂) may be repeatedly displayed in temporal succession at a high rate (preferably double the original frame rate), so that the human eye is able to integrate the luminance of the two luminance levels. This process converts pixel values in a frame into two pixel values that may be shown sequentially; in effect, a frame is converted into two sub-frames that are rendered sequentially.

The details of choosing GLS₁ and GLS₂ can be done via for example weight functions. Alternatively, for example a set of rules may be applied to distinguish between different ranges of luminance values. In another example, a look-up table is employed in which values of luminance GLS_{f} are mapped into pairs of high and low drive values GLS₁ and GLS₂.

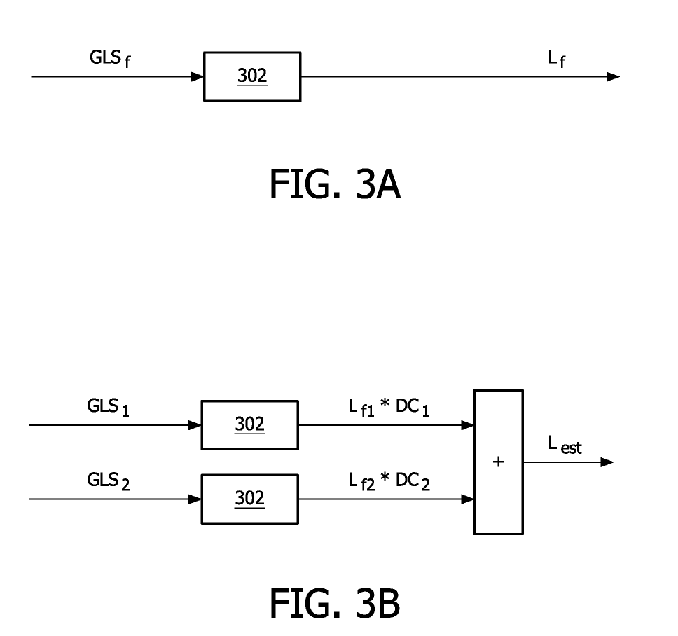

FIG. 3 illustrates an example of an algorithm framework that may be used for choosing sub-frame luminance values. Preferably, the use of two sub-frames is performed such that the overall Luminance value L_{f} is preserved, as far as the viewer is concerned. Ideally the simple equation below should be valid:

L_{f}=(L_{f1}+L_{f2})/2, (1)

wherein L_{f1} and L_{f2} correspond to the sub-frame luminance values, and wherein the duration of each of the sub-frames is 50% of the frame period. However, this may not be the case, as explained below.

FIG. 3A shows how a grey level signal (GLS_{f}) is used to drive a display 302, which results in a luminance L_{f}. The display 302 is typically driven by grey level drive signals (GLS) having a certain bit precision (e.g. 8-bit precision), corresponding to a limited set of perceived luminance levels.

FIG. 3B shows a sequential display of grey level signal GLS₁ having duty cycle DC₁ followed by grey level signal GLS₂ having duty cycle DC₂. The luminance contribution when these grey level signals GLS₁ and GLS₂ are applied to the display 302 sequentially is L_{f1}*DC₁ and L_{f2}*DC₂, respectively, wherein L_{f1} is the luminance of the display pixel 302 in response to grey level signal GLS₁ and L_{f2} is the luminance of the display pixel 302 in response to gray level signal GLS₂. The human eye integrates these luminance contributions by addition, which results in an estimated luminance Lₑₛₜ=L_{f1}*DC₁+L_{f2}*DC₂. So equation (1) may be generalized to take into account the duty cycles:

L_{f}=L_{f1}*DC₁+L_{f2}*DC₂ (1a)

The estimated luminance Lₑₛₜ may only be an estimate of the desired luminance L_{f} which corresponds to gray level signal GLS_{f}, for example because of quantization errors in selecting GLS₁ and GLS₂.

It may not be possible to satisfy the condition in equation (1) or (1a) for all possible initial drive signals GLS_{f} because of the limited bit precision of the display drive signals. The occurring luminance error can be minimized by searching a pair of drive values that give a minimal deviation from the original luminance L_{f}. Of course, a pair of equal drive values would be a correct solution of equation (1), but because of the off-axis gamma distortion this obvious solution is not desired. Therefore, a possible luminance error limit E is introduced as shown in equation (2):

L_{sf1}+L_{sf2}−E≦L_{f}≦L_{sf1}+L_{sf2}+E, (2)

wherein L_{sf1}=L_{f1}*DC₁ and L_{sf2}=L_{f2}*DC₂.

The value E should be set to any acceptable error level. For example, E may be selected to be lower than the quantization error related to the display driver bit precision (or the perceived quantization error in multi-primary displays).

For a given bit precision and a given sub-frame duty cycle (DC) all possible drive signal pairs may be generated and then evaluated according to their average luminance. Assuming both sub frame duty cycles are the same may correspond to DC₁=DC₂=0.5. All pairs that satisfy equation (2) are then considered as possible candidates, out of which one solution pair may be chosen. Usually many candidate pairs will satisfy equation (2), which leaves room for further optimization.

A look-up table may be used that translates every grey level GLS_{f} into a pair of two other grey levels GLS₁ and GLS₂. The look-up table that translates GLS_{f} into GLS₁ and GLS₂ can be calculated off-line; hence the generation of the LUT does not need to be implemented into the display, which saves computing power in the display. The generation of the LUT depends on the application of this versatile technique. One example is the minimization of the gamma curve distortion, which is outlined above. Another, related, example is minimization of color shift.

In the example presented above, the minimization of the gamma distortion uses only one single gamma function, which makes the method applicable to standard LCD panels. Other display technologies (especially including TN, OCB, IPS, and FFS) may also benefit from the principles underlying the above example.

In an embodiment, an image is displayed by using two frames, whereby one frame is bright and the second frame is dark. If these frames are displayed in temporal succession at for example 60 Hz it may cause flicker. Flicker is the perception of a modulation of the brightness. Therefore the image frame rate is increased to for example 120 Hz to reduce the flicker effect. This puts considerable requirements on the panel driving electronics and the liquid crystal (LC) response. However, by taking proper precautions discussed below, the described technology may also be applied at a low frame rate (such as 60 Hz), without introducing flicker. This allows the improvement of the viewing angle at a low frame rate. Motion blur may also be improved, for example if a dark frame succeeds a bright frame, and preferably using 120 Hz driving.

In an embodiment, solutions are provided for reduced flicker and an improved off axis image quality by using a standard panel. Such an approach keeps implementation costs at a minimum. The flicker can be avoided by switching small pixels areas in opposite direction. This means one pixel (or a group of pixels) switches from a dark frame to a bright frame, whereas at the same time a neighboring pixel (or a group of pixels) switches from the bright frame to the dark frame. Both groups of pixels should be equally distributed across the screen in such a manner that the integral image (the perceived image frame, consisting of two sub-frames) does not flicker.

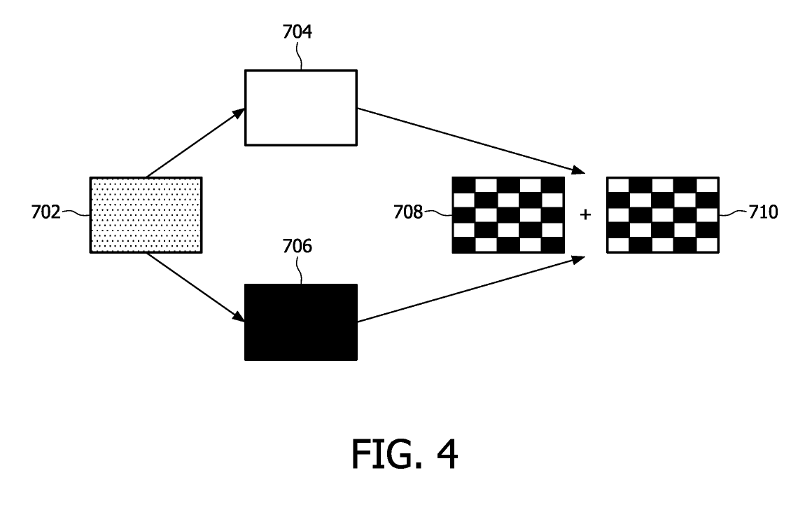

In an embodiment, the screen alters in a checkerboard fashion as depicted in FIG. 4. The tiles may have the size of one pixel. The tiles may also have the size of two adjacent pixels, or four adjacent pixels, e.g. a 2×2 square of pixels. Any size or shape of the tiles is allowable, however preferably the tiles are not too large in order to avoid the perception of artefacts. FIG. 4 illustrates an original image 702 (here a homogeneously grey image, for illustrational purpose), a bright sub-frame 704, a dark sub-frame 706, wherein the bright 704 and dark 706 sub-frames are derived from the original image 702 as set forth, and two modified sub-frames 708 and 710. The modified sub-frames show pieces of the bright sub-frame 704 and pieces of the dark sub-frame 706 in a checkerboard pattern, wherein the checkerboard pattern of the second modified sub-frame 710 has been inverted with respect to the first modified sub-frame 708.

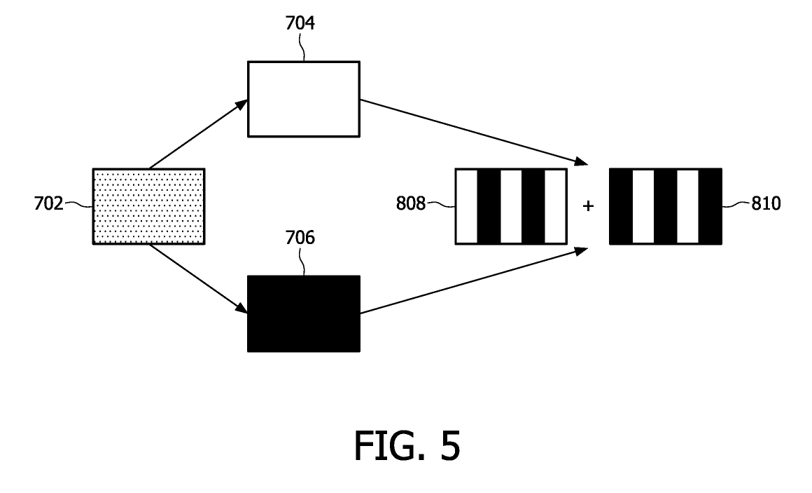

In an embodiment, the screen alters in a line pattern as depicted in FIG. 5. Reference numerals 702-706 in FIG. 5 point to items similar to those already described in relation to FIG. 4. The modified sub-frames 808 and 810 show vertical strips of pixels that are taken alternating from the dark sub-frame 706 and from the bright sub-frame 704. The line pattern of the second modified sub-frame 810 is inverted with respect to the first modified sub-frame 808. The width of the lines in pixels may be one or more pixels. Preferably, the lines taken from the bright sub-frame 704 are as wide as the lines taken from the dark sub-frame 706. Although in FIG. 5, vertical lines are displayed, other line arrangements including horizontal or diagonal lines are also possible.

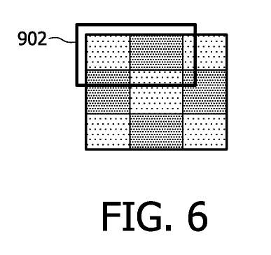

In the embodiments shown in FIG. 4 and FIG. 5, one image frame is converted into two sub-frames and these sub-frames are shown in temporal succession. Consequently, the effective frame rate of the display is double the frame rate of a video sequence that is rendered. However it is also possible to display the information (the dark and the bright pixel values) on two adjacent pixels beside each other. These two display pixels together may thus render one image pixel. Although this reduces the image resolution, it may be a very useful technique to realize a gain in viewing angle. Because a standard display may be used at the normal refresh rate, this constitutes an embodiment that is particularly economic to realize. The principle is illustrated in FIG. 6. In this figure, bright and dark pixels are distributed in a checkerboard pattern, however, other arrangements are also possible. Two adjacent pixels 902 on the display may be used to render the dark and the bright values of the same image pixel.

In an alternative embodiment, one of the sub-frames 708 and 710 is discarded and not rendered at all. When rendering a video sequence, for sequential image frames in the video sequence alternating either sub-frame 708 is rendered or sub-frame 710 is rendered. This has the advantage that the refresh rate of the display does not have to be doubled, and all of the pixels in the image frames do contribute to the end result, which increases the resolution and/or image quality of the rendering.

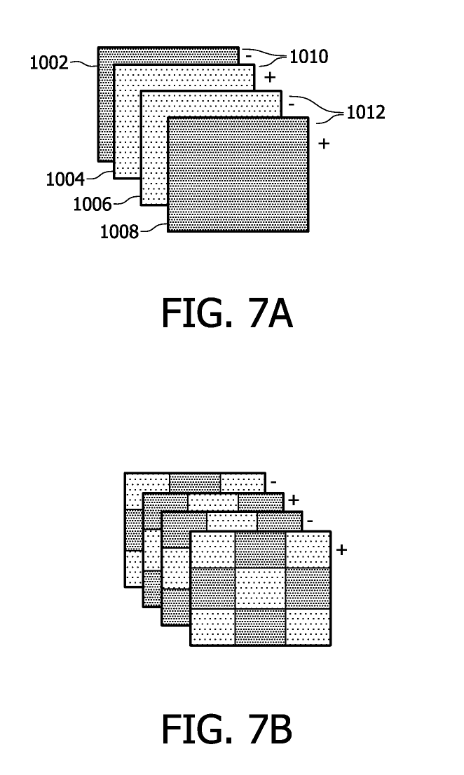

In another embodiment, the sequence of bright and dark sub-frame pixel values is adapted to avoid a DC build-up in the LCD. LCD's may be designed to employ an inversion scheme of plus, minus, plus, minus with time to avoid the DC build-up between electrodes within the LCD. This means, that the voltage applied to realize a certain color in a pixel is positive in one frame and negative in the next, and so on, alternating between positive and negative voltage from frame to frame. When the frames that are rendered are actually sub-frames having alternating high values and low values, the situation may occur that on the average, the positive voltage is in absolute value larger than the negative voltage. Also, the situation may occur that on the average, the negative voltage is in absolute value larger than the positive voltage. This may cause a DC build-up, which may be harmful for the LCD. To overcome this, the order of the sub-frames may be slightly changed, as illustrated in FIG. 7A and FIG. 7B.

FIG. 7A shows an order of rendering the sub-frames 1002, 1004, 1006, 1008 of sequential image frames 1010, 1012. To the right of each sub-frame, the sign of the voltage applied to the electrodes regulating the pixels of the LCD has been indicated by means of a + sign or a − sign. The voltage follows a plus, minus, plus, minus scheme. However, the sub-frames are ordered dark, bright, bright, dark. This way, after a sequence of four images, one dark sub-frame and one bright sub-frame has been rendered in the “plus” mode. Also, one dark sub-frame and one bright sub-frame has been rendered in the “minus” mode. This way, on the average the DC component is zero or very close to zero. The sub-frames of a frame 1012 are rendered in inverse order compared to the sub-frames of the previous frame 1010. If the sub-frames 1002, 1004 of the previous frame are rendered in the order of first the dark sub-frame 1002, followed by the bright sub-frame 1004, then the sub-frames 1006, 1008 of the frame 1012 are rendered in the order of first the bright sub-frame 1006, followed by the dark sub-frame 1008. The next frame is rendered in the order of the frame 1010, and so on.

FIG. 7B shows another ordering of the sub-frame rendering. In this case, there are no completely dark sub-frames or completely bright sub-frames; instead, the checkerboard pattern is used to divide the pixels into groups, wherein one group is for rendering portions of the dark sub-frame and the other group is for rendering portions of the bright sub-frame. Each group of pixels follows the rendering scheme that has been explained in relation to FIG. 7A (dark, bright, bright, dark), however, whenever one group is rendering the dark values, the other group will render the bright values. This helps to reduce the flicker effect that may occur when rendering full bright subframes and full dark subframes. Again, instead of checkerboard pattern, a line pattern or any other pattern may be used. Preferably, the pixels in each group are uniformly distributed over the image, as explained before.

The checkerboard pattern discussed in relation to the embodiments above may be employed for full pixels. However, each pixel may comprise a plurality of differently colored sub-pixels. For example, for each sub-pixel (e.g. Red, Green, Blue, possibly other or more colors), the upper and lower luminance values and/or signal drive values may be determined separately, in the way discussed above. Then, the pixels may be subdivided into the groups as discussed (e.g., a checkerboard pattern with one pixel in each checkerboard field), and each group may be driven alternating with upper drive values and lower drive values.

However, in another embodiment, the groups are defined on the sub-pixel level. For example, the sub-pixels are individually assigned to one of the groups, wherein a sub-pixel represents a particular color of the pixel. This way, the structure of the groups (e.g., checkerboard pattern, line pattern) can be refined, making this structure even less visible and further reducing any possible artifact effect arising from the chosen pattern or the used inversion scheme.

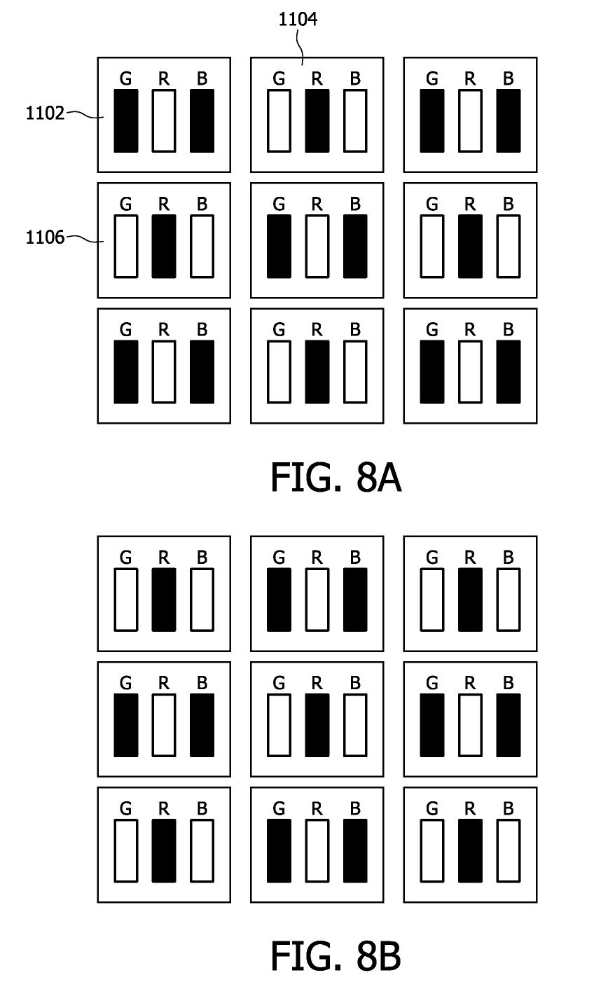

FIG. 8A and FIG. 8B illustrate an embodiment wherein the checkerboard pattern is implemented at a sub-pixel level. The two figures show two sequential sub-frames are applied to a small portion of the display. FIG. 8A shows a diagram of a detail of a grid of pixels of a display. One pixel 1102 comprises a plurality of sub-pixels, in this case three sub-pixels are provided, each sub-pixel of the three sub-pixels can render a predetermined color, for example green (G), red (R), or blue (B). Within pixel 1102, the green sub-pixel (G) is driven with a lower value (of a dark sub-frame), the red sub-pixel (R) is driven with an upper value (of a bright sub-frame), and the blue sub-pixel (B) is driven with an upper value of the bright sub-frame. Within the neighboring pixels 1104 and 1106, the green sub-pixel (G) is driven with an upper value (of the bright sub-frame), the red sub-pixel (R) is driven with a lower value (of the dark sub-frame), and the blue sub-pixel (B) is driven with a lower value of the dark sub-frame. This pattern is repeated, for example to form a checkerboard pattern.

FIG. 8B shows the same portion of the display shown in FIG. 8A, however the next sub-frame is shown. The role of each sub-pixel is exchanged: a sub-pixel displaying an upper value in FIG. 8A is displaying a lower value in FIG. 8B. This way the role of each sub-pixel is alternated for each sequential sub-frame that is rendered.

Many modifications and variations are possible, for example in selecting the patterns of the division of the sub-pixels into groups. In the example of FIG. 8A and FIG. 8B, the layout of the sub-pixels in the display is observed, and the checkerboard pattern is applied as if each sub-pixel were a field of the checkerboard. This results in an extremely uniform distribution of the groups over the display surface. However, other configurations are possible, for example green and red sub-pixels may be ‘in phase’ (i.e., both rendering upper values at the same time) and blue sub-pixel may be ‘out of phase’ with respect to the green and red sub-pixels (i.e., the blue sub-pixel may be rendering a lower value while the green and red sub-pixels are rendering an upper value). Different combinations of ‘in phase’ and ‘out of phase’ sub-pixels may be tried to obtain the least image artifacts.

The methods, systems, and concepts discussed herein can be used in various kinds of LCD displays including, but not limited to, transflective, reflective, and transmissive displays, TV displays, mobile phone displays or PDA's.

The methods, systems, and concepts discussed herein can also be used in color sequential displays. In color sequential displays, such as an RGB color sequential display, each image that is to be rendered is separated in its color components (in this case RGB), to form a single color image frame for each color component. These single color image frames are then displayed sequentially. Color sequential displays have some advantages, including the possibility to realize a higher resolution compared to a conventional panel at the same display size. Also, a higher possible transmittance may be realized (due to the omitted color filters). To avoid image flicker, such displays are often run at least 180 Hz. Separating each color image in a bright and a dark frame can improve the off-axis image quality. This separation can be displayed spatially as well as temporally, as is further explained below.

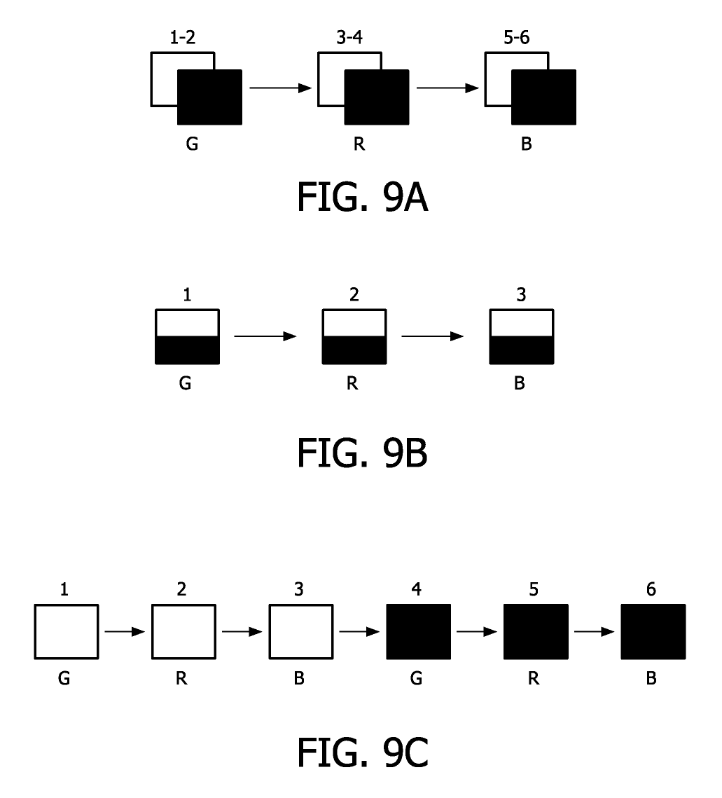

FIG. 9A illustratively shows a pixel of a color sequential display which is driven to render a pixel of six sequential sub-frames, all relating to a single original image frame, indicatively shown by means of dark boxes (lower pixel values) and white boxes (upper pixel values), G, R, and B indicating green, red, and blue rendering, respectively. The successive rendering of upper pixel values and lower pixel values helps to improve the viewing angle of such systems. As with the other embodiments, the pixels may be uniformly divided into groups, wherein the groups render the upper and lower pixel values at different times, i.e., when one group renders upper pixel values, the other group renders lower pixel values, and vice versa. Also, the sequence upper, upper, lower, lower may be employed as set forth, in particular when using a display that follows a plus, minus, plus, minus electrode polarity inversion scheme. Preferably, the frame rate (i.e., field rate) of the color sequential display is six times the frame rate of a video sequence to be rendered, because each frame of the video sequence is converted into six sub-frames as set forth.

In another embodiment using a color sequential display, the pixel could be made up of two or more sub-pixels, which can be driven independently. This situation is shown in FIG. 9B. In such a case, both the upper and lower drive values are rendered simultaneously, albeit spatially separated. Alternatively, two pixels of the display are used for rendering a single pixel of the image. Although this halves the resolution of the display, it is economic to realize as no special hardware is required.

In another embodiment using a color sequential display, illustrated in FIG. 9C, to render a color, the pixels are first driven with their respective three upper RGB values, and then they are driven with their respective three lower RGB values. This could also be done in the other order, so first the lower three values followed by the upper three values. This way, the difference between successive drive values will, on the average, be smaller. This allows the liquid crystals to arrive at the desired transparency value more quickly, which allows to increase the duty cycle, and allows for longer backlight flashes. It also allows to increase the field rate and frame rate.

In an embodiment, the distribution of pixels of each group is performed also on the basis of the content of the image to be displayed. In particular image areas having a large degree of picture detail may be rendered using the checkerboard pattern or the line pattern set forth herein. However, image areas having relatively little picture detail, for example larger areas of approximately the same color, for example a blue sky, is rendered in the more traditional impulse driving method, wherein all pixels are driven with the upper values at the same time and all pixels are driven with the lower values at the same time. This could help to reduce artifacts further in some cases, for example at relatively low refresh rates. It is also possible to adapt the pattern of the even distribution of the groups to the level of picture detail.

It will be appreciated that the invention also extends to computer programs, particularly computer programs on or in a carrier, adapted for putting the invention into practice. The program may be in the form of source code, object code, a code intermediate source and object code such as partially compiled form, or in any other form suitable for use in the implementation of the method according to the invention. It will also be appreciated that such a program may have many different architectural designs. For example, a program code implementing the functionality of the method or system according to the invention may be subdivided into one or more subroutines. Many different ways to distribute the functionality among these subroutines will be apparent to the skilled person. The subroutines may be stored together in one executable file to form a self-contained program. Such an executable file may comprise computer executable instructions, for example processor instructions and/or interpreter instructions (e.g. Java interpreter instructions). Alternatively, one or more or all of the subroutines may be stored in at least one external library file and linked with a main program either statically or dynamically, e.g. at run-time. The main program contains at least one call to at least one of the subroutines. Also, the subroutines may comprise function calls to each other. An embodiment relating to a computer program product comprises computer executable instructions corresponding to each of the processing steps of at least one of the methods set forth. These instructions may be subdivided into subroutines and/or be stored in one or more files that may be linked statically or dynamically. Another embodiment relating to a computer program product comprises computer executable instructions corresponding to each of the means of at least one of the systems and/or products set forth. These instructions may be subdivided into subroutines and/or be stored in one or more files that may be linked statically or dynamically.

The carrier of a computer program may be any entity or device capable of carrying the program. For example, the carrier may include a storage medium, such as a ROM, for example a CD ROM or a semiconductor ROM, or a magnetic recording medium, for example a floppy disc or hard disk. Further the carrier may be a transmissible carrier such as an electrical or optical signal, which may be conveyed via electrical or optical cable or by radio or other means. When the program is embodied in such a signal, the carrier may be constituted by such cable or other device or means. Alternatively, the carrier may be an integrated circuit in which the program is embedded, the integrated circuit being adapted for performing, or for use in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A driver (106) for driving pixels (104) of a display (102),
in at least an area (120) of the display, the pixels being divided into a first group and a second group;
the driver being constructed for supplying a first drive signal to a first pixel being one of the pixels out of the first group and a second drive signal to a second pixel being one of the pixels out of the second group, the first and second pixels being neighboring pixels;
wherein the driver (106) comprises
a value generator (116) for generating a first upper value and a first lower value, wherein the first upper value and the first lower value together correspond to a first pixel parameter value, the value generator being arranged for further generating a second upper value and a second lower value, wherein the second upper value and the second lower value together correspond to a second pixel parameter value; and
means (118) for driving, in an operating mode, the first pixel with the first lower value and the second pixel with the second upper value.

2. The driver according to claim 1,
the operating mode of the means for driving being referred to as the first operating mode;
wherein the means for driving is further arranged for, in a second operating mode, driving the first pixel with the first upper value and driving the second pixel with the second lower value;
the driver further comprising
means (108) for controlling the operating mode, alternating between the first operating mode and the second operating mode.

3. The driver according to claim 2, wherein the means for controlling the operating mode is arranged for alternating between the operating modes at a rate substantially equal to a frame rate of the display.

4. The driver according to claim 2, wherein the means for controlling the operating mode is arranged for alternating between the operating modes at a rate substantially half a frame rate of the display.

5. The driver according to claim 2,
wherein the driver is arranged for driving the plurality of pixels to render a sequence of images of a video sequence, wherein each image of the sequence of images is associated with a corresponding first pixel parameter value and a corresponding second pixel parameter value; and
wherein the means for controlling the operating mode is arranged for causing the driver to apply both the first operating mode and the second operating mode to each image.

6. The driver according to claim 5, wherein a frame rate of the display is substantially two times a frame rate of the video sequence.

7. The driver according to claim 5, wherein the means for controlling the operating mode is arranged for successively applying the first operating mode to a first image of the video sequence, applying the second operating mode to the first image of the video sequence, applying the second operating mode to a second image of the video sequence, and applying the first operating mode to the second image of the video sequence, wherein the first image and the second image are sequential images of the video sequence.

8. The driver according to claim 1, wherein substantially each pixel in the first one of the at least two groups of pixels is adjacent to at least one pixel in another one of the at least two groups of pixels and substantially each pixel in the second one of the at least two groups of pixels is adjacent to at least one pixel in another one of the at least two groups of pixels.

9. The driver according to claim 8, wherein the adjacent pixels of a given pixel in horizontal and vertical direction are not in the same group as the given pixel.

10. The driver according to claim 8, wherein the adjacent pixels of a given pixel in either one of horizontal and vertical direction are not in the same group as the given pixel, but the adjacent pixels of the given pixel in another one of horizontal and vertical direction are in the same group as the given pixel.

11. The driver according to claim 1, wherein the value generator (116) is arranged for further generating a third upper value and a third lower value, wherein the third upper value and the third lower value together correspond to a third pixel parameter value, wherein the first pixel parameter and the third pixel parameter represent mutually different sub-pixels; and wherein the value generator (116) is arranged for further generating a fourth upper value and a fourth lower value, wherein the fourth upper value and the fourth lower value together correspond to a fourth pixel parameter value, wherein the second pixel parameter and the fourth pixel parameter represent mutually different sub-pixels.

12. The driver according to claim 1 wherein the means for driving is arranged for driving, in the first operating mode, the first pixel with the first lower value and the third upper value and driving the second pixel with the second upper value and the fourth lower value and wherein the means for driving is arranged for driving, in the second operating mode, the first pixel with the first upper value and the third lower value and driving the second pixel with the second lower value and the fourth upper value.

13. The driver according to claim 1, wherein the display is a color sequential display.

14. The driver according to claim 13, wherein the value generator is arranged for generating upper and lower values for at least three pixel color parameters of a pixel, and wherein the means for driving is arranged for driving the pixel consecutively with the lower pixel color parameter values and for driving the pixel consecutively with the upper pixel color parameter values.

15. The driver according to claim 1 or 2,
further comprising means for identifying a first area of an image to be displayed and a second area of the image to be displayed, wherein the first area has more picture detail than the second area;
wherein the area of the display corresponds to the first area of the image, and the driver further comprises means for driving pixels in an area of the display corresponding to the second area of the image with the upper values and the lower values in phase.

16. A display device (100) comprising a display (102) and the driver (106) according to claim 1.

17. A method of driving pixels (104) of a display (102),
in at least an area of the display, the pixels being divided into a first group and a second group;
wherein the method comprises
supplying a first drive signal to a first pixel being one of the pixels out of the first group and a second drive signal to a second pixel being one of the pixels out of the second group, the first and second pixels being neighboring pixels;
generating a first upper value and a first lower value, wherein the first upper value and the first lower value together correspond to a first pixel parameter value;
generating a second upper value and a second lower value, wherein the second upper value and the second lower value together correspond to a second pixel parameter value; and
driving, in an operating mode, the first pixel with the first lower value and driving the second pixel with the second upper value.

18. A computer program product for displaying an image on a display (102), comprising software for causing execution of the method according to claim 17.
